(19) United States
(12) Patent Application Publication
(10) Pub. No.: US 2009/0035439 A1
(43) Pub. Date: Feb. 5, 2009

(54) Method and Ball Mill Apparatus for Manufacturing Powdered Tea

(76) Inventors: Jusuke Hidaka, Kyotanabe-shi (JP); Shinzo Yoshikado, Kyotanabe-shi (JP); Yoshiyuki Shirakawa, Kyotanabe-shi (JP); Yoshiaki Ito, Uji-shi (JP); Kiyoshi Hayakawa, Kizugawa-shi (JP); Yuuko Watanabe, Kizugawa-shi (JP)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 11/887,674

(22) PCT Filed: Mar. 31, 2006
(86) PCT No.: PCT/JP2006/306931

§ 371 Date: Sep. 28, 2007

(30) Foreign Application Priority Data
Mar. 31, 2005 (JP) 2005-101399

(51) Int. Cl. A23F 3/12; A47J 42/36; B02C 17/00

(52) U.S. Cl. 426/597; 241/28; 241/176

(57) ABSTRACT

A method capable of manufacturing, by using a ball mill apparatus, powdered tea having the same quality as that manufactured by using a millstone. By using the ball mill apparatus having synthetic resin pots, a powdered tea material and synthetic resin balls are sealed in the pot, and the pot is revolved or revolved and rotated on its axis to crush the powdered tea material.

### TECHNICAL FIELD

The present invention relates to a method for manufacturing powdered tea by using a ball mill apparatus, and a ball mill apparatus for manufacturing powdered tea.

### BACKGROUND ART

A traditional method for manufacturing Matcha (green powdered tea) and powdered tea by milling tea leaves with a millstone is known. When Matcha is manufactured by using the millstone, the tea leaves continuously pass through a milling section of the millstone so that veins of the tea leaves are certainly cut and a product of satisfactory quality is obtained.

However, according to such method, it takes a long time to mill the tea leaves into the powdered tea and it requires enormous skill to properly grind the millstone, and furthermore, the amount of the powdered tea manufactured per unit time is small.

In order to solve such problem, various methods for manufacturing Matcha or powdered tea using a ball mill apparatus have been proposed (see patent documents 1, 2, and 3). According to such methods, the tea leaves are milled into the powdered tea by using the ball mill apparatus provided with pots made of stainless steel, iron and the like together with balls made of chromium steel, ceramics, aluminum, zirconium, and the like.

However, the powdered tea manufactured by the conventional ball mill apparatus is inferior in taste to Matcha manufactured by the millstone. It is considered to be the main cause of the inferior quality of the powdered tea manufactured by the conventional ball mill apparatus that the tea leaves, in particular, the veins of the tea leaves are not cut into small pieces, but squashed, flattened and softened in collision with hard balls of large specific gravity so that a large amount of the tea leaves can not be reduced to a fine powder. Furthermore, in the conventional ball mill apparatus, a temperature of the tea leaves rises during milling process, which leads to degradation of the quality of the powdered tea to be manufactured. Moreover, if heavy metal such as chromium steel sphere etc. is used, generation of abrasion powder and the like may present problems in food sanitation.

Patent document 1: Japanese Laid-Open Patent Publication No. 2000-135057

Patent document 2: Japanese Laid-Open Patent Publication No. 2001-45971

Patent document 3: Japanese Laid-Open Patent Publication No. 2003-93907

### DISCLOSURE OF THE INVENTION

### Problems to be Solved by the Invention

Therefore, it is an object of the present invention to provide a method for manufacturing powdered tea by using a ball mill apparatus without arising the problems in food sanitation, the powdered tea having quality equivalent to that of powdered tea manufactured by a millstone.

Another object of the present invention is to provide a ball mill apparatus adapted for carrying out the above-mentioned method for manufacturing powdered tea.

### Means for Solving the Problems

In order to solve such problems, according to the present invention, there is provided a method for manufacturing powdered tea by using a ball mill apparatus provided with at least one synthetic resin pot, the method comprising: sealing the tea leaves in the pot together with at least one synthetic resin ball; and revolving the pot around a rotation axis of the apparatus, or rotating the pot around its axis while revolving the pot around the rotation axis of the apparatus so as to mill the tea leaves.

In this configuration, it is preferred that the inner diameter of the pot is 2.6 to 4 times as long as the diameter of the ball, and four to eight of the same balls are sealed in the pot.

It is also preferred that when an upper end opening of the pot is closed with a lid, a transition portion extending from a peripheral wall surface to a bottom wall surface in the pot, or a transition portion extending from the peripheral wall surface to an upper wall surface in the pot, or both of them are curved with a predetermined curvature radius, the curvature radius of each of the transition portions being equal to or greater than a curvature radius of the ball.

It is preferred that the height of the internal space of the pot is about 1.1 to 1.9 times as long as the diameter of the ball when an upper end opening of the pot is closed with a lid.

It is also preferred that the ball has a two-layered configuration composed of a spherical core and an outer layer overlaying the core, the core being made of a first synthetic resin, the outer layer being made of a second synthetic resin.

If the weight is too light with the ball made only from synthetic resin, a spherical metal core is embedded in the center of the ball, whereas if the weight is too heavy, a hollow ball is preferably used.

The synthetic resin may be a polymer of any type as long as it does not have toxicity to human body and excels in abrasion resistance, but in particular, it is preferably a polymer selected from a group consisting of polyacetal, Teflon (registered trademark), nylon, polyethylene, polypropylene, polycarbonate, polyphenylenesulfide, polymethylpentene, polyethersulfone, and polyethyleneterephthalate; or a mixture of two or more of the polymers; or a copolymer made of the constitution monomers selected from the polymers.

It is preferred that the pot is revolved around a rotation axis of the apparatus or rotated on its axis with a revolution speed and a duration of revolution predetermined in such a manner that a temperature in the pot is lower than or equal to a predetermined temperature during milling the tea leaves.

In order to solve the above-mentioned problems, according to the present invention, there is provided a ball mill apparatus for manufacturing powdered tea, comprising: at least one synthetic resin pot; and at least one synthetic resin ball, the pot being adapted for revolving around a rotation axis of the apparatus, or rotating on its axis while revolving around the rotation axis of the apparatus.

In this configuration, it is preferred that the inner diameter of the pot is 2.6 to 4 times as long as the diameter of the ball, and four to eight of the same balls are sealed in the pot.

It is also preferred that when an upper end opening of the pot is closed with a lid, a transition portion extending from a peripheral wall surface to a bottom wall surface in the pot, or a transition portion extending from the peripheral wall surface to an upper wall surface in the pot, or both of them are curved with a predetermined curvature radius, the curvature radius of each of the transition portions being equal to or greater than the curvature radius of the ball.

It is also preferred that the height of the internal space of the pot is about 1.1 to 1.9 times as long as the diameter of the ball when an upper end opening of the pot is closed with a lid.

### EFFECT OF THE INVENTION

According to the present invention, since the soft balls each of which has small specific gravity are used, during milling process, the tea leaves, particularly, the veins thereof are certainly cut into small pieces as compared with the hard balls of large specific gravity in the prior art. Furthermore, according to the present invention, since the pot and the balls are both made from synthetic resin, fragments of the tea leaves can collide with the pot and the ball while being fully dispersed due to frictional electricity generated by mutual contact and collision of the ball, the pot, and the fragments of the tea leaves.

As a result, the tea leaves are milled at the granularity equivalent to that of the tea leaves milled by the millstone, and the tea leaves are reduced to a fine powder of the same size as the commercially available Matcha (the average size of Matcha is about 3 to 4 μm). The obtained powdered tea has the quality equivalent to that of Matcha manufactured by using the millstone.

### BRIEF DESCRIPTION OF THE DRAWINGS

FIG. 1 is a perspective view of a ball mill apparatus with two pots arranged on a rotary table thereof, in which an operation panel unit and a protective cover for protection of the rotating pot during the operation of the ball mill apparatus are omitted.

FIG. 2 is a view showing one example of the pot, in which (A) is a perspective view and (B) is a longitudinal cross sectional view thereof.

FIG. 3 is a view showing the pot receiving the balls therein, in which (A) is a plane view, and (B) is a longitudinal cross sectional view thereof.

FIG. 4 is a view showing another example of the pot, in which (A) is a plane view of the pot receiving the balls therein, and (B) is a longitudinal cross sectional view thereof.

FIG. 5 is a view explaining a motion of the balls in the pot shown in FIG. 4 during milling process.

FIG. 6 is a graph showing a relationship between the diameter of the ball and the time elapsed from a start of operation of the ball mill apparatus to vanish of collision noise.

FIG. 7 is an optical microscope photograph of powdered tea obtained by the method of the present invention;

FIG. 8 is an optical microscope photograph of powdered tea obtained by the method of the present invention;

FIG. 9 is an optical microscope photograph of powdered tea obtained by a ball mill apparatus provided with stainless pot and balls.

FIG. 10 is an optical microscope photograph of Matcha obtained by using a millstone.

FIG. 11 is an optical microscope photograph of chitosan before milling process.

FIG. 12 is an optical microscope photograph of chitosan milled by using the method of the present invention.

### EXPLANATION OF SYMBOLS

1 rotary table
2 pot rotating board
3 pot
4 pot main body
4a peripheral wall surface
4b bottom wall surface
4c transition portion
5 lid
6 cavity
7 ring shaped packing
8 ball

### BEST MODE FOR CARRYING OUT THE INVENTION

A preferred embodiment of the present invention will now be described with reference to the accompanying drawings. According to the method for manufacturing powdered tea of the present invention, a ball mill apparatus provided with at least one synthetic resin pot and at least one synthetic resin ball is first prepared. In the ball mill apparatus, the pot can be revolved around the rotation axis of the apparatus, or rotated on its axis while being revolved around the rotation axis of the apparatus.

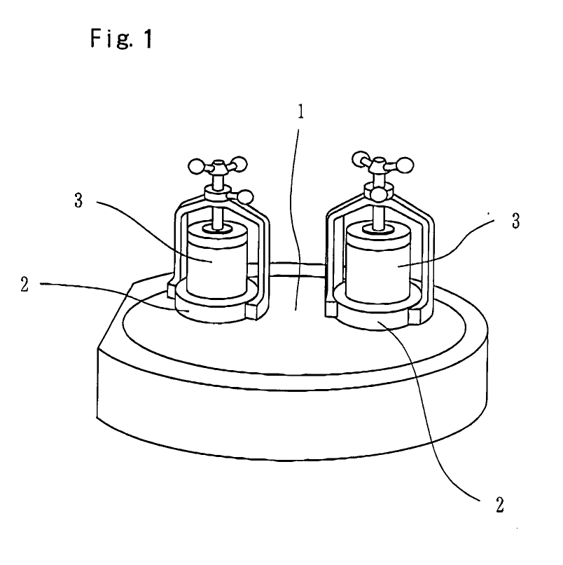

FIG. 1 is a perspective view of a ball mill apparatus with two pots arranged on a rotary table thereof. In FIG. 1, an operation panel unit and a protective cover for protection of the rotating pots during the operation of the ball mill apparatus are omitted.

The ball mill apparatus used in the method of the present invention has the same configuration as a conventional ball mill apparatus except for the pot and the balls. Therefore, the detailed explanation of the components other than the pot and the balls of the ball mill apparatus will be omitted.

With reference to FIG. 1, the ball mill apparatus includes a disc shaped rotary table 1 and pot rotating pedestals 2 arranged on the rotary table 1. The rotary table 1 is rotatably driven around the center axis thereof, and the pot rotating pedestals 2 are arranged so as to be rotatably driven with respect to the rotary table 1 around the respective center axis thereof. A pot 3 receives tea leaves together with balls and is securely fixed in an upstanding manner on the pot rotating pedestal 2, and is revolved around the center axis of the rotary table 1 by the drive of the rotary table 1 and rotated on its axis by the drive of the pot rotating pedestal 2.

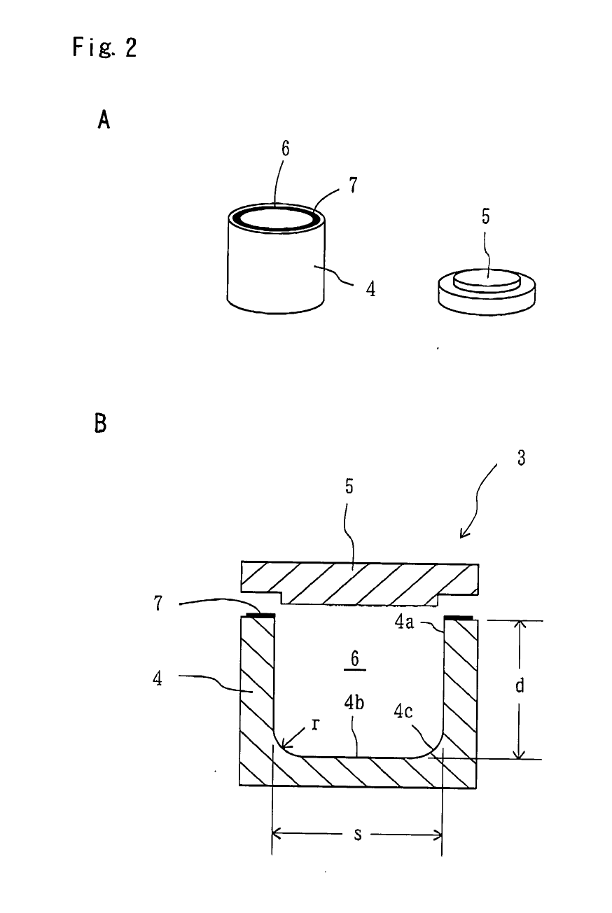

FIG. 2 is a view showing one example of the pot, in which (A) is a perspective view and (B) is a longitudinal cross sectional view thereof. As shown in FIG. 2, the pot 3 comprises a cylindrical pot main body 4 having one end closed, and a lid 5 for closing the opening of the other end of the pot main body 4 through a ring packing 7. A transition portion 4c extending from a peripheral wall surface 4a to a bottom wall surface 4b in a cavity 6 of the pot main body 4 is curved with a predetermined curvature radius r.

The pot 3 and the balls 8 are made of synthetic resin. The synthetic resin may be a polymer of any type as long as it does not have toxicity to human body, and excels in abrasion resistance, but in particular, it is preferably a polymer selected from a group consisting of polyacetal, Teflon (registered trademark), nylon, polyethylene, polypropylene, polycarbonate, polyphenylenesulfide, polymethylpentene, polyethersulfone, and polyethyleneterephthalate, or a mixture obtained by mixing two or more of such polymers, or a copolymer made of the constitution monomers selected from such polymers.

The pot 3 and the balls 8 made of the same type of synthetic resin does not always need to be combined for use, and the pot 3 and the ball 8 made of different type of synthetic resin may be combined for use.

It is sufficient that only the inner wall surface of the pot 3 is made of synthetic resin, where the pot 3 has the outer layer made of metal such as stainless steel or iron on the synthetic resin layer forming the inner wall surface in order to prevent deformation or the like.

In order to realize satisfactory milling, a specific gravity of the ball 8 may be appropriately changed depending on the dimensions of the balls 8 and the pot 3 as well as the kinds of tea leaves to be milled. As a method of changing the specific gravity of the balls 8, there is provided a method of preparing two types of synthetic resin whose specific gravity are different from each other, and forming the balls 8 as a two-layer configuration composed of a spherical core made of first synthetic resin and an outer layer made of a second synthetic resin overlaying the core, or a method of increasing the specific gravity by embedding a spherical metal core in the center of the balls 8, or a method of reducing the specific gravity by forming the balls 8 as hollow balls.

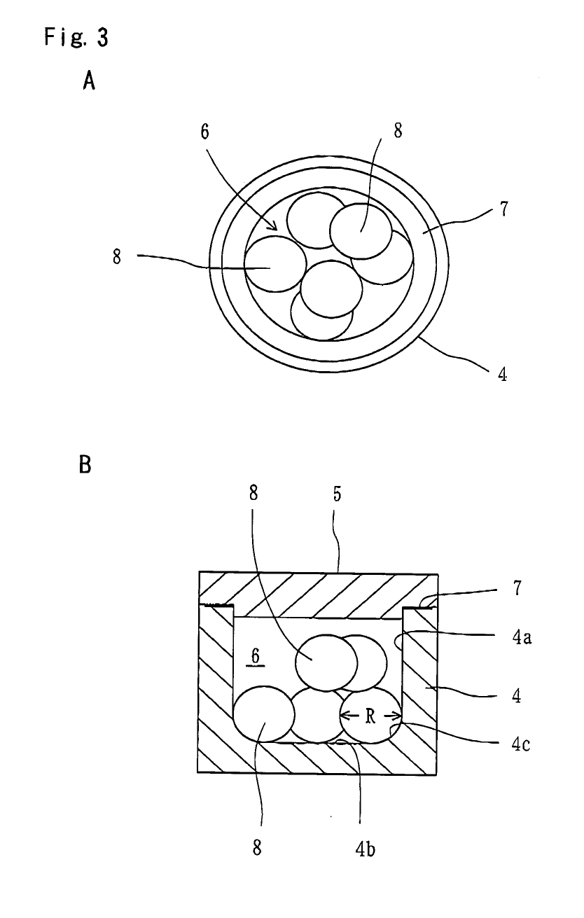

FIG. 3 is a view showing the pot receiving the balls therein, in which (A) is a plane view, and (B) is a longitudinal cross sectional view thereof. Referring to FIG. 3, the curvature radius r of the transition portion 4c extending from the peripheral wall surface 4a to the bottom wall surface 4b in the cavity 6 of the pot 3 is greater than or equal to the curvature radius of the ball 8.

In addition, the diameter s of the cavity 6 of the pot 3 is 2.6 to 4 times as long as the diameter R of the ball 8, where four to eight of the same balls 8 can be sealed in the pot 3.

According to the method for manufacturing powdered tea of the present invention, the tea leaves are sealed in the pot 3 together with the balls 8 and the pot 3 is attached to the ball mill apparatus, and the pot 3 is revolved around the center axis of the rotary table 1 or rotated on its axis (corresponding to the center axis of the pedestal 2) while being revolved around the center axis of the rotary table 1.

According to the method for manufacturing powdered tea of the present invention, veins of the tea leaves are certainly cut into small pieces at the same level as the tea leaves milled by the millstone, so that the tea leaves are reduced to a fine powder of a size equivalent to that of the commercially available Matcha. Thus the powdered tea having a quality equivalent to that of Matcha manufactured by using the millstone is obtained.

The pot and the balls were actually manufactured, and an experiment was performed so as to examine whether a desired result can be obtained. The experiment was performed according to the following procedure.

The following two types of pot of the ball mill apparatus were manufactured.

(a) pot No. 1: polyacetal pot having inner diameter s=40 mm and depth d=40 mm; and

(b) pot No. 2: stainless steel pot having inner diameter s=40 mm and depth d=40 mm.

The following three types of ball were manufactured.

(c) ball No. 1: nylon covered ball with iron sphere (specific gravity=about 3.2, diameter R=15 mm, number: six):

(d) ball No. 2: nylon ball (specific gravity=about 1.1, diameter R=15.89 mm, number: six); and

(e) ball No. 3: stainless steel ball (specific gravity=about 7.9, diameter R=15 mm, number: six).

### EXAMPLE 1

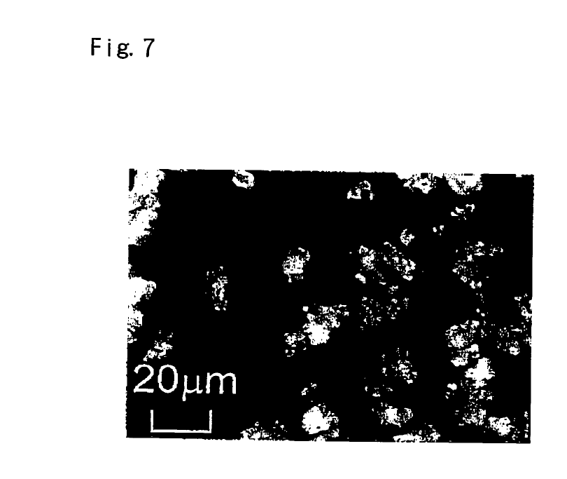

The ball mill apparatus was activated for 10 minutes, using the combination of pot No. 1 and ball No. 1 and using 50 g of Tencha as tea leaves, at revolution speed of 600 rpm (rotary table) and rotation speed of 600 rpm (pedestals), where a direction of the revolution (rotary table) is opposite to a direction of the rotation (pedestals). The optical microscope photograph of the obtained powdered tea is shown in FIG. 7.

### EXAMPLE 2

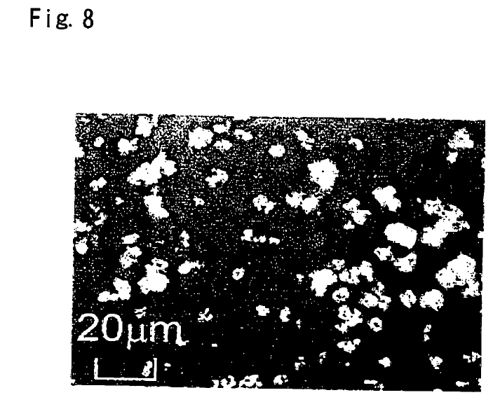

The ball mill apparatus was activated for 20 minutes, using the combination of pot No. 1 and ball No. 2 and using as much Tencha as that of the example 1, at revolution speed of 600 rpm (rotary table) and rotation speed of 600 rpm (pedestals), where a direction of the rotation (rotary table) is opposite to a direction of the rotation (pedestals). The optical microscope photograph of the obtained powdered tea is shown in FIG. 8.

### COMPARATIVE EXAMPLE 1

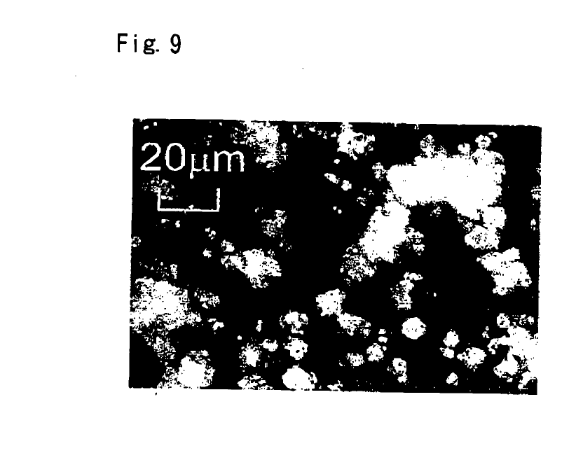

The ball mill apparatus was activated for 10 minutes, using the combination of pot No. 2 and ball No. 3 and using as much Tencha as that of the example 1, at the revolution speed of 600 rpm (rotary table) and the rotation speed of 600 rpm (pedestals), where a direction of the revolution (rotary table) is opposite to a direction of the rotation (pedestals). The optical microscope photograph of the obtained powdered tea is shown in FIG. 9.

### COMPARATIVE EXAMPLE 2

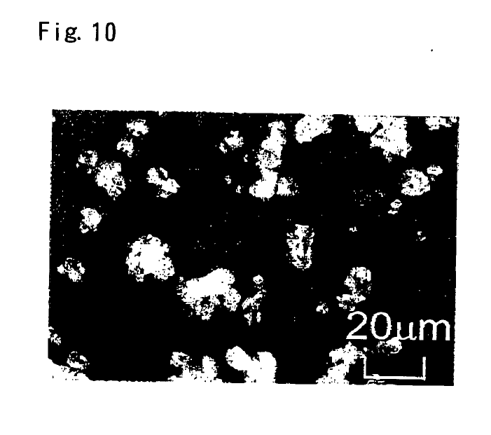

Matcha was manufactured by a millstone from the same Tencha that used in the example 1. The optical microscope photograph of the obtained Matcha is shown in FIG. 10.

The results of the examples 1, 2 and the results of the comparative examples 1, 2 are comparatively reviewed.

In the example 1, veins of Tencha were reliably cut, and Tencha were reduced to a fine powder and milled at the granularity substantially equivalent to that of Matcha obtained in the comparative example 2. The obtained powdered tea was substantially similar to Matcha obtained in the comparative example 2 with respect to hand feeling.

In the example 2, similar to the example 1, Tencha was evenly milled and the average grain diameter of the obtained dust tea was smaller than that of Matcha obtained in the comparative example 2.

In the comparative example 1, the average grain diameter of the obtained dust tea was relatively large and the veins of Tentcha were not finely cut, but squashed. The obtained powdered tea was rough to the feel in comparison with Matcha obtained in the comparative example 2. The powdered tea also had a slight astringent taste.

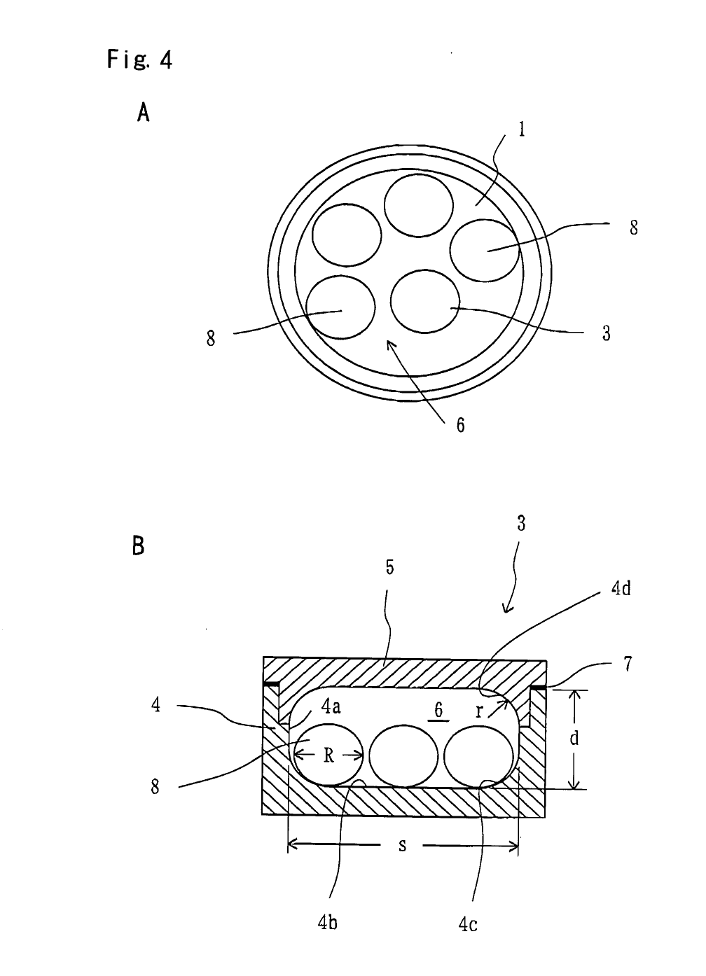

FIG. 4 is a view showing another example of a pot, where (A) is a plane view of the pot receiving the balls therein, and (B) is a longitudinal cross sectional view thereof. The example of FIG. 4 is different from the example of FIG. 3 in an internal configuration thereof. In FIG. 4, the same reference numerals are denoted for the same components as shown in FIG. 3, and thus the detailed description thereof will be omitted.

With reference to FIG. 4, the transition portion 4c extending from the peripheral wall surface 4b to the bottom wall surface 4b in the internal space 6 of the pot 3 and a transition portion 4d extending from the peripheral surface 4a to an upper wall surface are curved with a predetermined curvature radius r when an upper end opening of the pot main body 4 is closed by the lid 5. In this case, the curvature radii of the transition portions 4c, 4d are equal to or greater than the curvature radius of the ball 8.

In this example, the height d of the internal space 6 of the pot 3 is about 1.1 to 1.9 times as long as the diameter R of each of the balls 8 when the upper end opening of the pot main body 4 is closed by the lid 5. Therefore, in this example, the balls 8 will not be arranged in two levels within the pot 3.

Similar to the example shown in FIG. 3, the diameter s of the cavity of the pot 3 is 2.6 to 4 times as long as the diameter of each of the balls 8, and four to eight of the same balls 8 can be sealed in the pot 3.

The tea leaves are sealed in the pot 3 together with the balls 8 and the pot 3 is attached to the ball mill apparatus, and the pot 3 is revolved around the center axis of the rotary table 1 or rotated on its axis (corresponding to the center axis of the pedestal 2) while being revolved around the center axis of the rotary table 1.

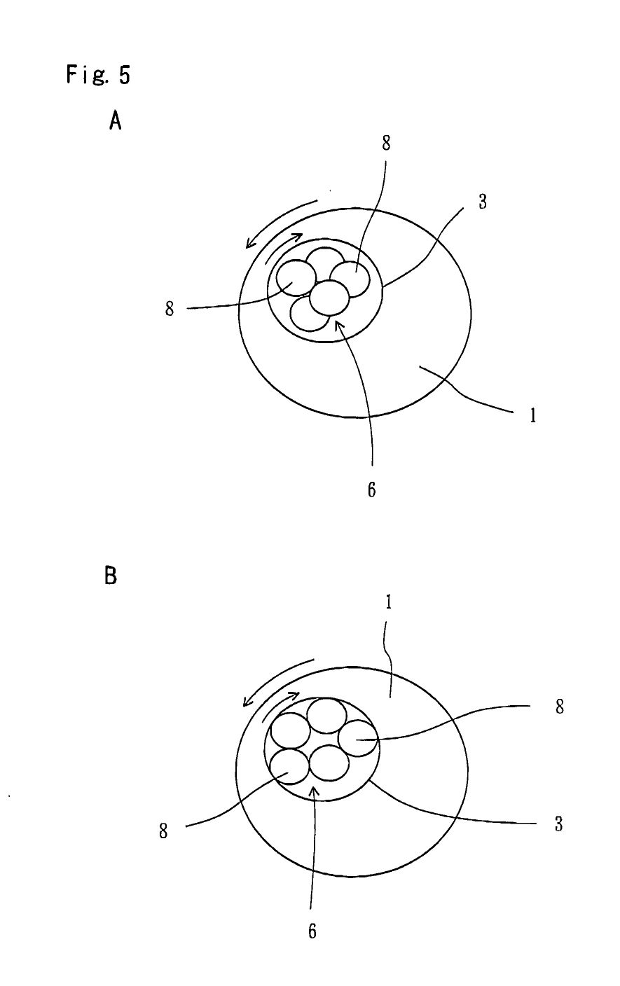

In this example, the balls 8 move disorderly in an initial stage of a milling process since a viscosity of the tea leaves is large during movement of the balls 8 in the pot 3 conducting a sun-and-planet motion, so that a collision between the balls 8 and a collision between the ball 8 and the inner wall of the pot 3 frequently occur (see FIG. 5(A)), which generates a collision noise. During the collision, the tea leaves enter between the balls 8 or between the ball 8 and the inner wall of the pot 3 so as to be milled.

When the tea leaves are milled at a certain degree by the collision between the balls 8 and between the balls 8 and the pot 3, the viscosity of the milled tea leaves lowers and a force of inducing the disorder of the motion of the balls 8 becomes weaker, whereby all the balls 8 start an orderly motion, the collision as described above does not occur (see FIG. 5(B)), so that the collision noise vanishes. Thereafter, the tea leaves are further milled and reduced to a fine powder mainly by the shearing force induced by the relative motion of an agglomerate of the balls 8 and the inner wall of the pot 3.

A time elapsed from start of operation of the ball mill apparatus to vanish of the collision noise depends on the speed of the revolution and rotation of the pots 3, a kind of tea leaves, and the amount and average grain diameter of the powdered tea to be manufactured. If all of the speed of the revolution and rotating of the pots, the kind of the tea leaves, and the amount and average grain diameter of the powdered tea to be manufactured are the same, the time becomes longer as the viscosity of the powder becomes larger, whereas if the speed of the revolution and rotation, and the kind of the tea leaves are the same, the time becomes longer as the amount of the powdered tea to be manufactured increases.

As a result, the milling process is one for roughly grinding the tea leaves while the collision noise is being produced, and the milling process is one for further grinding the roughly grinded raw tea to fine pieces after the impact noise vanishes. After the collision noise vanishes, the milling process preferably continues in order to further pulverize the powdered tea.

In this example as well, the powdered tea having the quality equivalent to that of the powdered tea manufactured by the millstone is obtained, similar to the examples of FIGS. 1 to 3.

According to the method of the present invention, as the speed of the revolution and rotation of the pots increase, or as the duration of the revolution and rotation becomes longer, the temperature in the pots rises. Such rise in temperature is caused by both collision and shearing force.

If the temperature in the pot drastically rises while milling the tea leaves, the powdered tea to be manufactured is discolored and quality such as smell and flavor thereof is deteriorated by heat. In order to manufacture the powdered tea of satisfactory quality, it is desirable to perform milling at the temperature lower than or equal to 50° C. Thus, the speed and duration of the revolution and rotation of the ball mill apparatus are desirably determined in such a manner that rise in temperature in the pot is maintained to be lower than or equal to 50° C. during milling process.

The trial milling is repeatedly performed in advance, the temperature in the pot is measured using an infrared thermometer or the like immediately after the termination of milling, the range of the speed and duration of the revolution and rotation, which leads to the result that the rise in temperature during milling process becomes about lower than or equal to 50° C., is determined and tabulated for every dimension of the pots and the balls, type of the tea leaves, and the amount of powdered tea to be manufactured based on the acquired data, and the speed and duration of the revolution and rotation are set every time according to the relevant table in the actual operation.

The pot and the balls were then actually manufactured, and an experiment was performed so as to examine whether a desired result can be obtained. The content of the demonstration experiment is as follows:

(f) pot No. 3: polyacetal pot having inner diameter s=110 mm, depth d=65 mm, curvature radius r=20 mm of the transition portion extending from the peripheral surface to the bottom wall surface and the upper wall surface.

The following ball was manufactured.

(c) ball No. 4: polyacetal ball (specific gravity=about 1.45, diameter R=35 mm, number: five).

### EXAMPLE 3

The ball mill apparatus was activated for 20 to 60 minutes, using the combination of pot No. 3 and ball No. 4 and using 50 g each of Tencha, refined green tea, natural leaf tea, twig tea, and roasted tea as tea leaves, at the revolution speed of 600 rpm (rotary table) and the rotation speed of 600 to 640 rpm (pedestals), where a direction of the revolution (rotary table) is opposite to a direction of the rotation (pedestals).

The grain size distribution of the obtained powdered tea was measured, and the grain size distribution of the obtained powdered tea was the same level as that of each of the examples of FIGS. 1 to 3.

### EXAMPLE 4

Five polyacetal balls having different diameters were used, and the ball mill apparatus was activated using 50 g each of twig tea and Tencha as tea leaves, at the revolution speed of 300 to 320 rpm (rotary table) and the rotation speed of 600 to 640 rpm (pedestals), where a direction of the revolution (rotary table) is opposite to a direction of the rotation (pedestals), similar to example 3, so as to measure the time elapsed from start of operation of the ball mill apparatus to vanish of the collision noise.

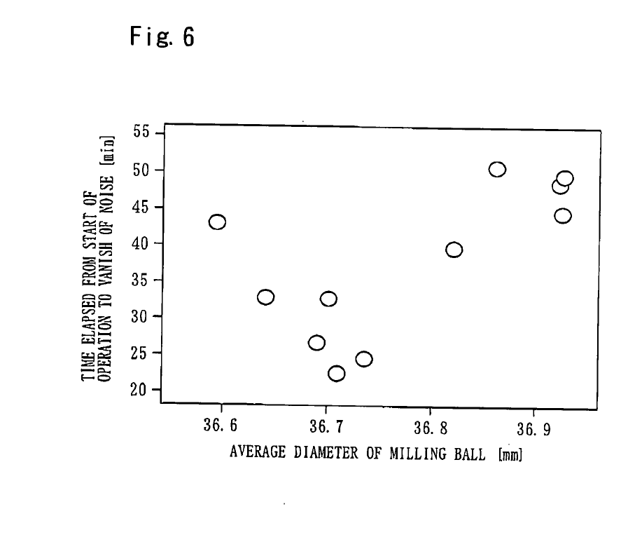

The result of the measurement is shown in a graph of FIG. 6. In the graph of FIG. 6, a vertical axis indicates the time (min.) elapsed from start of operation of the ball mill apparatus to vanish of the collision noise, and the horizontal axis indicates the diameter (mm) of the balls. As apparent from FIG. 6, when the inner diameter of the pot is 110 mm, a noise reduction time is about 20 minutes if the diameter of the ball is 36.7 mm, which is about half of that of the balls having different diameters. Thus, it can be recognized that a ratio of the inner diameter of the pot to the diameter of the ball greatly influences the milling process of the powdered tea.

The preferred examples of the present invention has been described, but the method of the present invention can be applied to not only grinding tea leaves (twig tea, crude tea, natural leaf tea, refined green tea, Tencha), but also grinding herbal medicine (Chinese herbal medicine) and chitosan, grinding dried food (dried bonito flake, dried kelp, fungus, dried abalone and the like), grinding pearls and grinding chemicals.

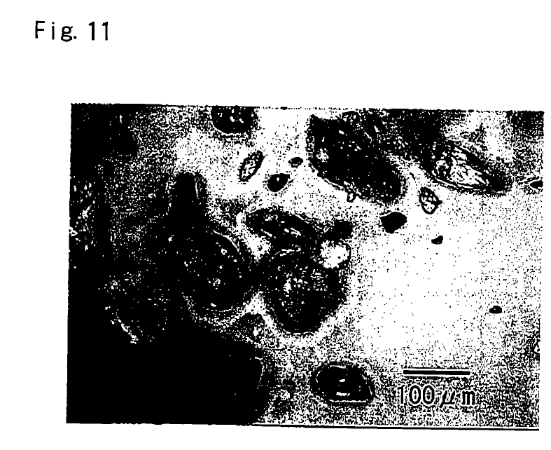

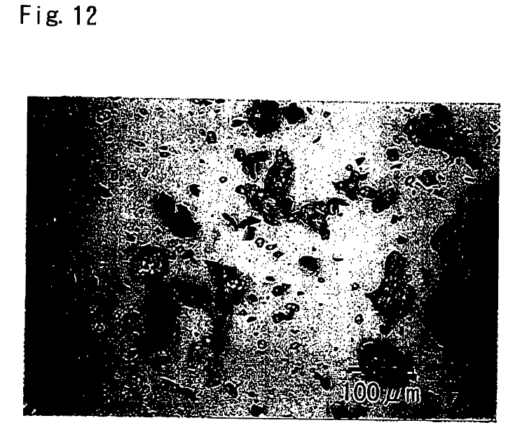

FIG. 11 and FIG. 12 show optical microscopic photographs of the example in which the method of the present invention is applied to grinding chitosan. FIG. 11 is the optical microscopic photograph of chitosan before grinding, and FIG. 12 is the optical microscope photograph of chitosan grinded by the method of the present invention. As apparent from comparing FIG. 12 and FIG. 11, though chitosan is difficult to mill by conventional grinding method because it is composed of strong fibers, chitosan can be very easily grinded evenly, similar to tea leaves, by using the method of the present invention.

1-24. (canceled)

25: A method of manufacturing powdered tea by using a ball mill apparatus provided with at least one synthetic resin pot, said method comprising the steps of:
sealing tea leaves in said pot together with at least one synthetic resin ball; and
revolving said pot around a rotation axis of said apparatus, or rotating said pot on its axis while revolving said pot around the rotation axis of said apparatus, so as to mill the tea leaves.

26: A method of manufacturing powdered herbal medicine, or powdered chitosan, or powdered dried food, or powdered pearls, or powdered chemicals, by using a ball mill apparatus provided with at least one synthetic resin pot, said method comprising the steps of:
sealing the herbal medicine, or the chitosan, or the dried food, or the pearls, or the chemicals, as a raw material in said pot together with at least one synthetic resin ball; and
revolving said pot around a rotation axis of said apparatus, or rotating said pot on its axis while revolving said pot around the rotation axis of said apparatus, so as to mill the raw material.

27: The method of claims 25 or 26, and configuring an inner diameter of said pot to be 2.6 to 4 times as long as a diameter of said ball, and sealing four to eight of the same balls in said pot.

28: The method of claims 25 or 26, and closing an upper end opening of said pot with a lid, and curving a transition portion extending from a peripheral wall surface to a bottom wall surface in said pot, or curving a transition portion extending from the peripheral wall surface to an upper wall surface in said pot, or curving both of said transition portions with a predetermined curvature radius, said curvature radius of each of said transition portions being equal to or greater than a curvature radius of said ball.

29: The method of claims 25 or 26, and configuring a height of an internal space of said pot to be about 1.1 to 1.9 times as long as a diameter of said ball when closing an upper end opening of said pot with a lid.

30: The method of claims 25 or 26, and configuring said ball with a two-layered configuration composed of a spherical core and an outer layer overlaying said core, making said core of a first synthetic resin, and making said outer layer of a second synthetic resin.

31: The method of claims 25 or 26, and embedding a spherical metal core in a center of said ball, or configuring said ball to be hollow.

32: The method of claim 30, and constituting the synthetic resin as a polymer selected from a group consisting of polyacetal, Teflon®, nylon, polyethylene, polypropylene, polycarbonate, polyphenylenesulfide, polymethylpentene, polyethersulfone, and polyethyleneterephthalate; or a mixture of two or more of said polymers; or a copolymer made of the constitution monomers selected from said polymers.

33: The method of claims 25 or 26, and revolving or rotating said pot with a revolution speed and a duration of revolution predetermined in such a manner that a temperature in said pot is lower than or equal to a predetermined temperature during milling.

34: A ball mill apparatus for manufacturing powdered tea, comprising:
at least one synthetic resin pot; and
at least one synthetic resin ball,
said pot being adapted for revolving around a rotation axis of said apparatus, or rotating on its axis while revolving around said rotation axis of said apparatus.

35: A ball mill apparatus for manufacturing powdered herbal medicine, or powdered chitosan, or powdered dried food, or powdered pearls, or powdered chemicals, comprising:
at least one synthetic resin pot; and
at least one synthetic resin ball,
said pot being adapted for revolving around a rotation axis of said apparatus, or rotating on its axis while revolving around said rotation axis of said apparatus.

36: The ball mill apparatus of claims 34 or 35, wherein an inner diameter of said pot is 2.6 to 4 times as long as a diameter of said ball, and four to eight of the same balls are sealed in said pot.

37: The ball mill apparatus of claims 34 or 35, wherein, when an upper end opening of said pot is closed with a lid, a transition portion extending from a peripheral wall surface to a bottom wall surface in said pot, or a transition portion extending from the peripheral wall surface to an upper wall surface in said pot, or both of them are curved with a predetermined curvature radius, said curvature radius of each of said transition portions being equal to or greater than a curvature radius of said ball.

38: The ball mill apparatus of claims 34 or 35, wherein a height of an internal space of said pot is about 1.1 to 1.9 times as long as a diameter of said ball when an upper end opening of said pot is closed with a lid.
